(19) United States
(12) Patent Application Publication
(10) Pub. No.: US 2017/0087562 A1
(43) Pub. Date: Mar. 30, 2017

(54) METHOD FOR DETERMINING TREATMENT RESPONSE OF CELLS

(71) Applicants: NATIONAL CHENG KUNG UNIVERSITY, Tainan City (TW); National Cheng Kung University Hospital, Tainan City (TW)

(72) Inventors: Wei-lun HUANG, Tainan City (TW); Wu-chou SU, Tainan City (TW); Wei-pang CHUNG, Tainan City (TW); Hai-wen CHEN, Tainan City (TW); Hsien-chang CHANG, Tainan City (TW)

(21) Appl. No.: 15/274,480

(22) Filed: Sep. 23, 2016

Related U.S. Application Data
(60) Provisional application No. 62/232,267, filed on Sep. 24, 2015.

(51) Int. Cl. B03C 5/00; G01N 27/447

(52) U.S. Cl. CPC B03C 5/005; G01N 27/447

(57) ABSTRACT

A method for determining a treatment response of cells is provided with steps of providing a un-treated first sample and a treated second sample; applying an electric signal to the first sample and the second sample; obtaining a first motion parameter of the first sample and a second motion parameter of the second sample in the electric signal, respectively; and comparing the first motion parameter and the second motion parameter to determine whether there is a difference. The difference represents that the treatment response exists.

### CROSS REFERENCE TO RELATED APPLICATIONS

This application claims the benefit of the filing date of U.S. provisional patent application Ser. No. 62/232,267, filed on Sep. 24, 2015, the disclosure of which is incorporated herein by reference.

### FIELD OF THE INVENTION

The present invention relates to a method for determining a treatment response of cells, and in particular relates to a method for determining a treatment response of cells based on a dipole moment effect by applying an electrodynamic method to the cells.

### BACKGROUND OF THE INVENTION

In recent years, cancers have been the first cause of death, not only in the United States and the European Union, in Taiwan as well. With the development of molecular biology and cell biology, a variety of specific target drugs (small molecule drugs and other target drugs, such as monoclonal antibodies) have already been developed. The target drugs have excellent clinical outcomes and side effects below the traditional chemotherapy. They improve not only a patient's survival, but also the life quality of the patient. However, the success of a targeted therapy depends on a proper drug selection. For example, in the case of use of epidermal growth factor receptor inhibitors, the patient with mutation of epidermal growth factor receptor has a response rate ranged from 60% to 85%, but the patient without mutation of epidermal growth factor receptor has only a response rate ranged from 10% to 15%. Therefore, how to choose a target drug appropriate to the patient is a challenge for a clinician. For correctly choosing the appropriate target drug, firstly, it is necessary to confirm whether the cancer cells express specific drug targets (e.g. the mutation of epidermal growth factor receptor), or the corresponding biomarkers (e.g. E-cadherin expression). Thus, how to analyze cancer cells becomes the most important issue of personalized cancer treatments now.

In order to achieve the correct treatment, patients need to accept the analysis of these biomarkers (e.g. the mutation of epidermal growth factor receptor). However, the traditional detecting methods, such as gene sequencing, polymerase chain reaction examination, immunohistochemical detection, generally need large amount of cells, longer analysis period, and more expansive cost.

The patients have expression of these biomarkers are suitable for use of target drugs, but others are still treated by chemotherapy and radiation therapy. However, the chemotherapy and the radiation therapy have no biomarker for predecting the treatment effect, so the clinicians only use the clinical database to determine whether the chemotherapy or radiation therapy should be administrated to the patient, and the drug types/doses of the chemotherapy or the radiation therapy. Therefore, if there is a method for assisting the clinician to quickly determine the required condition according to the specific status of each patient (suitable drug types/does of the chemotherapy and suitable doses of the radiation therapy), it will help them to design therapeutic program and the success rate of the chemotherapy and the radiation therapy will be improved.

The electrodynamic method, such as electrorotation (ER), dielectrophoresis (DEP), and traveling-wave DEP, can be used for analysis, controlling, and separation based on differences of the dielectric properties between the particles. In the past studies, the dielectrophoresis principle is first to be used to distinguish live and dead cells, and oral cancer cells with different cancerous degrees in recent. Therefore, these electrodynamic technologies are possible to be applied to biomedical field. However, there is no method for estimating or determining the treatment response of cells by utilizing the electrodynamic methods, currently.

It is therefore necessary to provide a method for determining a treatment response of cells, in order to solve the problems existing in the conventional technology as described above.

### SUMMARY OF THE INVENTION

A primary object of the present invention is to provide a electrodynamic method based on a dipole moment to determine a treatment response of a cell thereby predict a treatment effect thereof. The treatment response can be classified into responding (sensitive) type, non-responding (tolerant or resistant) type, intermediate type, and a type requiring other indexes to determine, and they are capable of providing clinicians an estimated information. The method is beneficial to establish a treatment project.

To achieve the above objects, the present invention provides a method for determining a treatment response of cells, comprising steps of: (1) providing a first sample containing a first cell and an electrolyte liquid, and a second sample containing a second cell and the electrolyte liquid, wherein the first cell and the second cell are the same type of cells obtained from a specimen, the second cell is treated by a treatment method, and the first cell is not treated by the treatment method or treated by a comparative treatment method; (2) applying an electric signal to the first sample and the second sample so as to generate a dipole moment effect of the first cell and a dipole moment effect of the second cell, respectively; (3) obtaining at least one first motion parameter of the first cell corresponding to the electric signal, and at least one second motion parameter of the second cell corresponding to the electric signal; and (4) comparing the first motion parameter and the second motion parameter to determine a treatment response of the second cell to the treatment method; wherein a difference between the first motion parameter and the second motion parameter represents that the treatment response exists; or no difference between the second motion parameter and the first motion parameter represents that the treatment response does not exist.

In one embodiment of the present invention, in the step (2), the dipole moment effect of the first cell and the dipole moment of the second cell are generated by an electrodynamic method so that the first cell is allowed to move, change a moving direction, accelerate, slow down, rotate, change a rotating direction, increase a rotating speed, decrease a rotating speed, or be motionless; and the second cell is allowed to move, change a moving direction, accelerate, slow down, rotate, change a rotating direction, increase a rotating speed, decrease a rotating speed, or be motionless.

In one embodiment of the present invention, the electrodynamic method is dielectrophoresis, traveling-wave dielectrophoresis, or electrorotation.

In one embodiment of the present invention, the first motion parameter and the second motion parameter are rotating directions, rotating speeds, rotating angles, rotating angular accelerations, moving directions, moving speeds, moving distances, or accelerations.

In one embodiment of the present invention, the treatment method is selected from a group consisting of targeted therapy, radiation therapy, chemotherapy, inhibiting cell death, accelerating proliferation, inhibiting proliferation, angiogenesis accelerating therapy, angiogenesis inhibiting therapy, immune activation therapy, immunosuppressive therapy, thermal therapy, photodynamic therapy, differentiation accelerating therapy, differentiation inhibiting therapy, and the combination thereof.

In one embodiment of the present invention, the comparative treatment method is a placebo treatment method, or an invalid treatment method.

In one embodiment of the present invention, the treatment response is activation, deactivation, cell death acceleration, cell death inhibition, proliferation acceleration, proliferation inhibition, angiogenesis acceleration, angiogenesis inhibition, immunity activation, immunity suppression, injury, differentiation acceleration, differentiation inhibition, other effects which the therapeutic agents designed to offer or the combination thereof.

In one embodiment of the present invention, the first cell and the second cell are blood cells, mesenchymal stem cells, circulating tumor cells (CTCs), tumor cells, non-tumor cells, malignant cells, non-malignant cells, gene recombinant cells, non-gene recombinant cells, stem cells, non-stem cells, cancer stem cells, artificial differentiated cells, in vitro cultured cells, xenograft cells, or the combination thereof.

In one embodiment of the present invention, the specimen is treated by a pre-treatment, or not treated by a pre-treatment, or the combination thereof.

In one embodiment of the present invention, the pre-treatment is a physical treatment, chemical treatment, biological treatment, or the combination thereof.

In one embodiment of the present invention, the pre-treatment comprises at least one method selected from a group consisting of biochip method, density gradient method, magnetic bead method, flow cytometry method, optical driving method, selective osmotic cell lysis method, particle size selective screening method, enzyme digestion method, in vitro cultivation method, centrifugation method, selective affinity method, other physical, chemical, or biological treatment, and the combination thereof.

In one embodiment of the present invention, the specimen comprises body fluids, solid tissues, a non-organized specimen, an in vitro cultivated specimen, an xenograft specimen, or the combination thereof.

In one embodiment of the present invention, when the treatment response exists, the treatment response, according to the degree of the difference, is classified into responding type, intermediate type, and a type requiring other indexes to determine; when the treatment response does not exist, the treatment response is determined as non-responding type.

In one embodiment of the present invention, the responding type represents sensitivity to the treatment method; and the non-responding type represents resistance (tolerance) to the treatment method including de novo resistance or acquired resistance.

### BRIEF DESCRIPTION OF THE DRAWINGS

FIG. 1 is a schematic view showing a device for an electrorotation in a method for determining a treatment response of cells according to one embodiment of the present invention.

FIGS. 2A to 2B show the electrorotation speed curves of the cells without mutation of EGFR (AS2, A549, H460, and H157) and the cells with mutation of EGFR (HCC827, PC-9, PC-9/GEF, and H1975) before EGFR TKI (Iressa) treatment.

FIG. 3 shows the electrorotation speed curves of the drug resistant cells AS2 without mutation of EGFR before and after EGFR TKI (Iressa) treatment for 6 hours.

FIG. 4 shows the electrorotation speed curves of the sensitive cells HCC827 with mutation of EGFR before and after EGFR TKI (Iressa) treatment for 6 hours.

FIG. 5 shows the electrorotation speed curves of the drug resistant cells H1975 before and after EGFR TKI (Iressa) treatment for 6 hours.

FIGS. 6A to 6B show the variation of cell EGFR message pathway of the drug resistant cells AS2 without mutation of EGFR, the sensitive cells HCC827 with mutation of EGFR, and the drug resistant cells H1975 before and after EGFR TKI (Iressa) treatment for 6 hours (FIG. 6A); and the variation of proliferation inhibition/cells kill of the drug resistant cells AS2 without mutation of EGFR, the sensitive cells HCC827 with mutation of EGFR, and the drug resistant cells H1975 after EGFR TKI (Iressa) treatment for 72 hours (FIG. 6B).

FIGS. 7A to 7B show the cell type and the electrorotation speed curves of the lung cancer cells PC-9 after the radiation therapy with different doses (2 Gy, 10 Gy) and the placebo treatment (0 Gy) for 31 hours.

FIG. 8 shows the cell cultures analysis (Colony Formation Assay) and the quantitative trend curves of the lung cancer cells PC-9 after different doses (2 Gy, 8 Gy, 10 Gy) of radiation and the placebo treatment (0 Gy) for 2 weeks.

FIG. 9 is a schematic view showing a device of the traveling-wave dielectrophoresis in a method for determining a treatment response of cells according to one embodiment of the present invention.

FIGS. 10A to 10B show the electrodes available for the traveling-wave dielectrophoresis in a method for determining a treatment response of cells according to one embodiment of the present invention.

FIG. 11 is a schematic view showing a device of the traveling-wave dielectrophoresis in a method for determining a treatment response of cells according to one embodiment of the present invention.

FIG. 12 shows the variation of the moving speeds of the lung cancer cells AS2 in the traveling-wave dielectrophoresis after chemotherapy treatment with Taxol and the placebo treatment for 24 hours according to one embodiment of the present invention.

FIG. 13 shows the cell type and the proliferation inhibition/cells kill of the lung cancer cells AS2 after the chemotherapy treatment with Taxol and the placebo treatment for 24 hours and 48 hours according to one embodiment of the present invention.

FIGS. 14A to 14D show the traveling-wave dielectrophoresis chip used for analyzing the cancer cells and the white blood cells separated from the pleural effusion of a lung cancer patient by the biochip (FIG. 14A), by the density gradient separation (FIG. 14B); FIG. 14C shows the traveling-wave dielectrophoresis chip used for analyzing the peripheral blood mononuclear ball cells of a healthy subject separated by the density gradient separation; FIG. 14D shows the traveling-wave dielectrophoresis chip used for analyzing the peripheral blood circulating tumor cells and the white blood cells separated by the biochip.

### DETAILED DESCRIPTION OF THE PREFERRED EMBODIMENTS

The structure and the technical means adopted by the present invention to achieve the above and other objects can be best understood by referring to the following detailed description of the preferred embodiments. Furthermore, if there is no specific description in the invention, singular terms such as “a”, “one”, and “the” include the plural number. For example, “a compound” or “at least one compound” may include a plurality of compounds, and the mixtures thereof. If there is no specific description in the invention, “%” means “weight percentage (wt %)”, and the numerical range (e.g. 10% to 11% of A) contains the upper and lower limit (i.e. 10%≦A≦11%). If the lower limit is not defined in the range (e.g. less than, or below 0.2% of B), it means that the lower limit may be 0 (i.e. 0%≦B≦0.2%). The proportion of “weight percent” of each component can be replaced by the proportion of “weight portion” thereof. The abovementioned terms are used to describe and understand the present invention, but the present invention is not limited thereto.

One embodiment of the present invention provides a method for determining a treatment response of cells, mainly comprising steps as follows: (S1) providing a first sample and a second sample; (S2) applying an electric signal to the first sample and the second sample; (S3) obtaining at least one first motion parameter of the first sample and at least one second motion parameter of the second sample corresponding to the electric signal, respectively; and (S4) comparing the first motion parameter and the second motion parameter to determine whether there is a difference. The principle and the implementation details of each step in this embodiment of the present invention will be described in detail hereinafter. The treatment method of the present invention comprises all means for providing a therapeutic effect (e.g. a targeted therapy, radiation therapy, or chemotherapy); the treatment response indicates the expected outcomes achieved by the means for providing the therapeutic effect (e.g. messaging inhibition, proliferation inhibition/cells kill, and tumor suppression, etc.).

First, the method for determining a treatment response of cells according to one embodiment of the present invention is the step (S1): providing a first sample and a second sample. In this step, the first sample and the second sample can be used for comparing the cells before and after treating with a treatment method. The first sample contains a first cell and an electrolyte liquid; the second sample contains a second cell and the electrolyte liquid. That is, the first cell and the second cell are suspended within a medium made of the electrolyte liquid. The first cell and the second cell are obtained from the same type of cell of a specimen, for example, lung cancer cells from the same tissue of the same patient; the white blood cells from the same blood specimen of the same patient, but they are not limited thereto. Preferably, the second cell can be treated by a treatment method. Therefore, it can be understood that the first cell is not treated by the treatment method, and the first cell can be a comparison with the second cell. Thus, the treatment method can be determined whether it is effective (available) for the second cell.

Optionally, in this step, the first sample and the second sample can be used for comparing a cell treated by a comparative treatment method with a cell treated by the treatment method. The first cell can be treated by the comparative treatment method, and the second cell is treated by the treatment method. The comparative treatment method is for example a placebo treatment method, or an invalid treatment method. Therefore, the first cell can be a negative comparison to be used for determining whether the treatment method is effective (available).

Optionally, a third sample can be included in this step. The third sample contains a third cell and the electrolyte liquid. The third cell is the same type of cell with the first cell and the second cell in the same specimen, which are for example lung cancer cells obtained from the same tissue of the same patient; the white blood cells obtained from the same blood specimen of the same patient, but they are not limited thereto. Preferably, the third cell is treated by a second treatment method. Therefore, it can be understood that the first cell and the second cell are not treated by the second treatment method, and the first cell and the second cell both can be comparisons with the third cell. Thus, the second treatment method can be determined whether it is more effective (available) than the treatment method. However, the present invention is not limited thereto, the same principle can be applied to analyze the treatment response and the treatment effect of various treatment methods to the same type of cells from the same specimen before administrating the treatment method to the patient.

The abovementioned treatment method and the second treatment method can be independently selected from a group consisting targeted therapy, radiation therapy, chemotherapy, cell death inhibiting therapy, proliferation acceleration therapy, proliferation inhibition therapy, angiogenesis acceleration therapy, angiogenesis inhibition therapy, immune activation therapy, immunosuppressive therapy, thermal therapy, photodynamic therapy, differentiation accelerating therapy, differentiation inhibiting therapy, other means for providing therapeutic effects, and the combination thereof, but they are not limited thereto. In addition, the treatment method, the second treatment method, and the comparative treatment method can be a treatment program based on the adjustment of doses, drugs, treatment duration, or variables on clinical treatment, but it is not limited thereto. Therefore, the treatment effect of the treatment method or the second treatment method can be estimated before administrating to the patient.

In one embodiment of the present invention, the first cell and the second cell are blood cells (Red blood cells, platelets, white blood cells), mesenchymal stem cells, circulating tumor cells, tumor cells, non-tumor cells, malignant cells, non-malignant cells, gene recombinant cells, non-gene recombinant cells, stem cells, non-stem cells, cancer stem cells, artificial differentiated cells, in vitro cultured cells, xenograft cells, or the combination thereof, but they are not limited thereto. In one embodiment of the present invention, the specimen is treated by a pre-treatment, or not treated by a pre-treatment, or the combination thereof. The specimen can be a body fluid, such as blood, pleural effusion, or ascites, but it is not limited thereto; the specimen can also be a solid tissue, such as the tissues from surgery or sliced specimen, but it is not limited thereto; the specimen can be a non-organized specimen, such as free cells; the specimen can also be an in vitro cultivated specimen, such as in vitro cultivated blood cells or various stem cells, cancer cells cultivated for a short term in vitro; or the combination of the foregoing specimens. The pre-treatment can be a physical, chemical, biological treatment, or the combination thereof. The pre-treatment can be biochip method, density gradient method, magnetic bead method, flow cytometry method, optical driving method, selective osmotic cell lysis method, particleparticle size selective screening method, enzyme digestion method, in vitro cultivation method, centrifugation method, selective affinity method, other physical, chemical, or biological treatment, and the combination thereof, but it is not limited thereto. The magnetic bead method is for example an immunomagnetic method utilizing antibodies, and a magnetic bead method utilizing aptamer. The optical driving method is for example optical tweezers, or optically induced dielectrophoresis. The selective osmotic cell lysis is for example red blood cell lysis. The particle size selective screening method is for example use of cell strainers having different aperture diameters. The enzyme digestion method is for example a use of collagenase. The in vitro cultivation can be in vitro cultivated blood cells or various stem cells, cancer cells cultivated for a short term in vitro. The selective affinity can be performed by utilizing Nylon Wool and T cells, or Heparin and cells having carbohydrate thereon.

Next, the method for determining a treatment response of cells according to one embodiment of the present invention is the step (S2): applying an electric signal to the first sample and the second sample. In this step, the first cell and the second cell are allowed to generate a dipole moment effect by the electric signal respectively. The dipole moment effect can be generated by an electrodynamic method so that the first cell or the second cell is allowed to move, change a moving direction, accelerate, slow down, rotate, change a rotating direction, increase a rotating speed, decrease a rotating speed, start moving or be motionless. Optionally, the electrodynamic method can be dielectrophoresis, electrorotation, traveling-wave dielectrophoresis, other way to drive the dipole moment, or the combination thereof.

Preferably, the electrorotation can be composed by a plurality of electrodes (over three electrode, for example, four, five, six, seven, eight, twelve) and planar or 3D biochip. For example, eight electrodes can be divided into two sets of electrodes and disposed on and under the biochip at the peripheral area. Each set of electrodes includes four electrodes apart each other by 90 degrees, and the two set of electrodes are aligned to each other; the chip is configured to contain the first sample or the second sample. The electrorotation comprises steps of (S2A) applying a negative electrophoresis force through the eight electrodes so as to fix the first cell or the second cell at a center portion of the chip; and (S2B) applying an electric signal through the four electrodes of each set of the electrodes, wherein the electric signal has a periodic variation in value and direction (such as a sine wave), and performs continuous phase variation by time, so as to provide the first cell or the second cell a source of torque.

Next, the method for determining a treatment response of cells according to one embodiment of the present invention is the step (S3): obtaining at least one first motion parameter of the first sample and at least one second motion parameter of the second sample corresponding to the electric signal, respectively. In this step, the first cell has at least one first motion parameter corresponding to the electric signal. When there are three or more first motion parameters, the first motion parameters can form a first motion parameter curve. The second cell can also have at least one second motion parameter corresponding to the electric signal. When there are three or more second motion parameters, the second motion parameters can form a second motion parameter curve. In one embodiment of the present invention, the first motion parameter and the second motion parameter can be rotating directions, rotating speeds, rotating angles, rotating angular accelerations, moving directions, moving speeds, moving distances, or accelerations, but they are not limited thereto.

After the step (S3), the method can further comprise a step of (S3A) obtaining at least one third motion parameter of the third sample corresponding to the electric signal. in this step, the third cell has at least one third motion parameter corresponding to the electric signal. When there are three or more third motion parameters, the third motion parameters can form a third motion parameter curve. The third motion parameters can be rotating directions, rotating speeds, rotating angles, rotating angular accelerations, moving directions, moving speeds, moving distances, or accelerations, but they are not limited thereto.

Furthermore, the first motion parameter, the second motion parameter, and the third motion parameter can be a value obtained from direct measurement or calculation, or be a non-numeric parameter, but they are not limited thereto.

Optionally, in this step, the first motion parameter, the second motion parameter, the third motion parameter, or more motion parameters in different batch of experiments can be individually or commonly accumulated to form a data bank to assist determination of the same type of cells treated by the same treatment method later. The first motion parameter, the second motion parameter, the third motion parameter, or more motion parameters can be statistic or analyzed the reliability, but they are not limited thereto. For example, when estimating the treatment response of lung cancer cells from a patient A treated by targeted therapy, the data information of lung cancer cells from other patients treated by targeted therapy can be used as assistant indexes for determination.

Next, the method for determining a treatment response of cells according to one embodiment of the present invention is the step (S4): comparing the first motion parameter and the second motion parameter to determine whether there is a difference to determine a treatment response of the second cell to the treatment method. The difference between the first motion parameter and the second motion parameter represents that the treatment response exists; or no difference between the second motion parameter and the first motion parameter represents that the treatment response does not exist.

After the step (S4), the method can further comprise a step (S4A) comparing the first motion parameter and the third motion parameter to determine whether there is a difference to determine a second treatment response of the second treatment method. The difference between the first motion parameter and the third motion parameter represents that the second treatment response exists. According to the degree of the difference, the treatment effect of the second treatment method or the treatment method can be determined (more effective or less effective). When the difference between the second motion parameter and the first motion parameter is more than the difference between the third motion parameter and the first motion parameter, the treatment method is more effective, or on the contrary, the second treatment method is more effective. If there is no difference between the third motion parameter and the first motion parameter, which represents that the second treatment response does not exist.

Optionally, the first motion parameters corresponding to the electric signal can form a curve diagram to observe the trend of the first motion parameters. Similarly, the trend of the second motion parameters can be observed. When the two curves have a significant difference in value or shape, which represents that the two cells have “a treatment response” or “a difference of a treatment response” regarding the treatment method; when the two curves have no significant difference in value or shape, which represents that the two cells have “no treatment response” or “no difference of a treatment response” regarding the treatment method. In one embodiment of the present invention, according to the degree of the difference, the above “have a treatment response” can be classified into responding type, intermediate type, and a type requiring other indexes to determine; the above “no treatment response” represents non-responding type; the above “have a difference of a treatment response”, according to the degree of the difference, can be classified into more effective/less effective, and a type requiring other indexes to determine; the above “no difference of a treatment response” represents that the treatment effect has no difference. In one embodiment of the present invention, the “treatment response” is activation, deactivation, cell death acceleration, cell death inhibition, proliferation acceleration, proliferation inhibition, angiogenesis acceleration, angiogenesis inhibition, immunity activation, immunity suppression, injury, differentiation acceleration, differentiation inhibition, or the treatment response expected by other treatment method, but it is not limited thereto. In one embodiment of the present invention, the above “responding type” represents sensitivity to the treatment method; and the “non-responding type” represents primary drug resistance (de novo resistance) or acquired drug resistance to the treatment method.

To make the method for determining a treatment response of cells provided by the present invention more definite, please refer to the experiment process and the results described in the following.

### Experiment 1. Electrorotation

### Experiment Apparatus

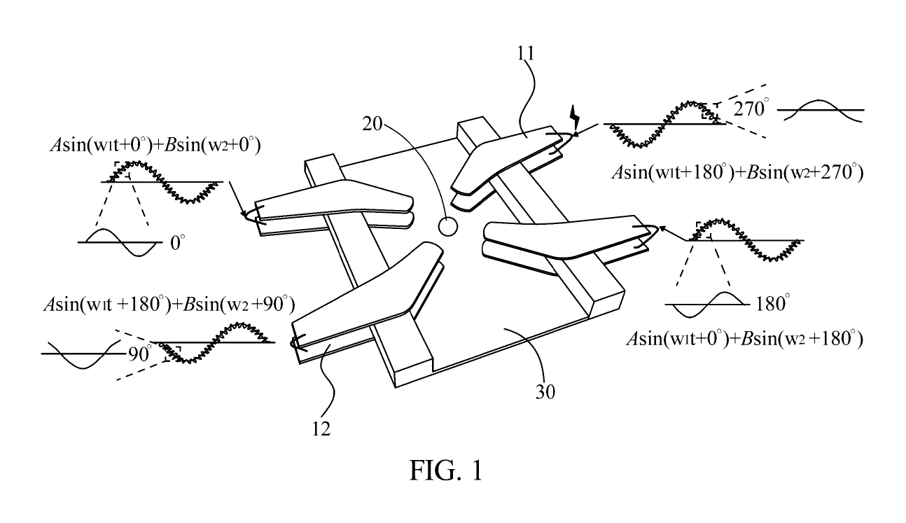

As shown in FIG. 1, an electrorotation device has eight electrodes divided into two sets, comprising an upper electrode set 11 (four electrodes) and a lower electrode set 12 (four electrodes), and a carrier 30 (or biochip). The upper electrode set 11 and the lower electrode set 12 are aligned to each other (X-Y overlap), and disposed on the carrier 30 having a containing space for the first sample or the second sample. The first sample or the second sample can locate with the electrodes at the same space, or preferably, be spaced (contactless) by other device for reducing the damage caused by the electrodes on the cells and the consumption of the electrodes. A negative electrophoresis force is applied through the upper electrode set 11 and the lower electrode set 12, and the test cell 20 can be pushed toward the middle portion of the upper electrode set 11 and the lower electrode set 12, preferably the center portion of the eight electrodes, thereby fixing the test cell 20. Meanwhile, 360/N of sine wave signal are subsequently applied to the upper electrode set 11 and the lower electrode set 12, wherein N is preferably equal to 4, so that the sine wave of the electrodes have intervals of 90 degrees from each other, but N is not limited thereto. The wave signal of the electrodes aligned to each other can be the same or different, and continuously change the phase thereof by time to provide the source of the torque for electrorotation. The frequency of the wave signal is 0.1 KHz to 10 MHz, preferably 25 KHz to 1.5 MHz, for example 75 KHz, 100 KHz, or 500 KHz, but it is not limited thereto; the voltage is 0.01 V to 500 V, preferably 0.1 V to 20 V, for example 1V, 5V, or 15V, but it is not limited thereto.

### Experiment Process

Step. 1: The test cell 20 is placed into an electrolyte liquid with an appropriate conductivity, pH value, and osmolarity, and injected to fill the carrier 30. The conductivity is ranged from 0.01 to 100 mS/cm, preferably 0.1 to 10 mS/cm, for example 0.1, 1, or 10, but it is not limited thereto; the pH value is ranged from 3.5 to 10.5, preferably from 5.5 to 8.5, for example 7.0, 7.2, or 7.4, but it is not limited thereto; the osmolality is ranged from 50 to 2000 mOsm/kg, preferably 250-350, for example 270, 300, or 330 mOsm/kg, but it is not limited thereto. Next, the electrolyte liquid containing the test cell 20 is injected into a containing space on the carrier 30.

Step 2: A negative electrophoresis force is applied through the upper electrode set 11 and the lower electrode set 12, and the test cell 20 can be pushed toward the middle portion of the upper electrode set 11 and the lower electrode set 12, preferably the center portion of the eight electrodes, thereby fixing the test cell 20.

Step 3: 360/N of sine wave signal are subsequently applied to the upper electrode set 11 and the lower electrode set 12, wherein N is preferably equal to 4, so that the sine wave of the electrodes have intervals of 90 degrees from each other, but N is not limited thereto. The wave signal of the electrodes aligned to each other can be the same or different, and continuously change the phase thereof by time to provide the source of the torque for electrorotation so that the test cell 20 rotates.

Step 4: Observing or recording the rotating condition of the test cell 20. Image device such as charge-coupled device (CCD), complementary metal-oxide-semiconductor (CMOS), or other appropriate observation device can be used together with microscopes, but they are not limited thereto.

Step 5: Calculating rotating speeds of the test cell 20 by using image analysis software (e.g. Image J) or manual analysis, but it is not limited thereto.

Step 6: Analyzing a test cell 20 treated by a treatment method (e.g. targeted therapy, radiation therapy, or chemotherapy) to obtain relation and the relative degree between the variation of the electrodynamic effect and the treatment response, and further estimate the treatment effect of the test cell 20 treated by the treatment method. The treatment response comprises, but not limited to, messaging inhibition, cell culture formation, or proliferation inhibition/cells kill.

Treatment Method: targeted therapy, radiation therapy, or chemotherapy.

Targeted therapy: tyrosine kinase inhibitor (TKI), such as epithelium growth factor receptor (EGFR) specific tyrosine kinase inhibitor (EGFR TKI), including first generation, second generation, and third generation EGFR TKI.

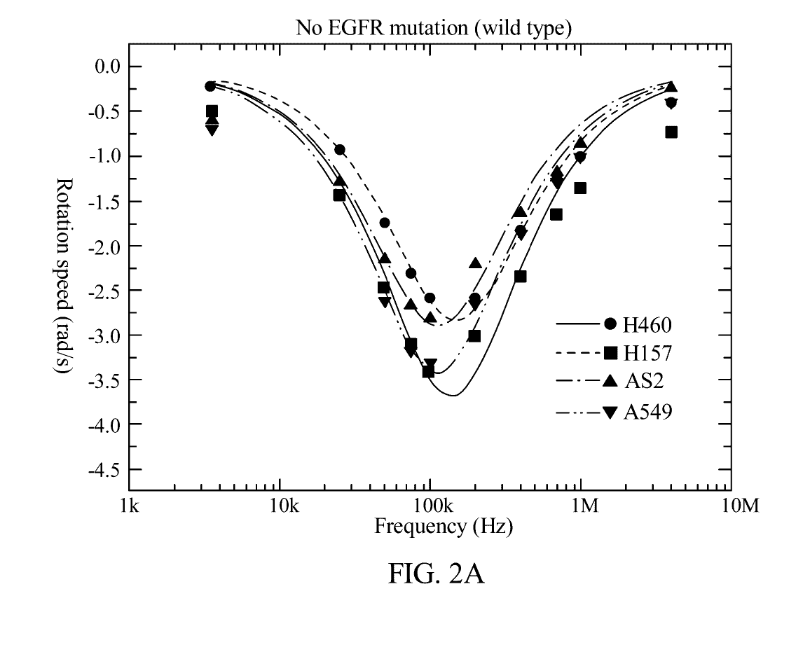

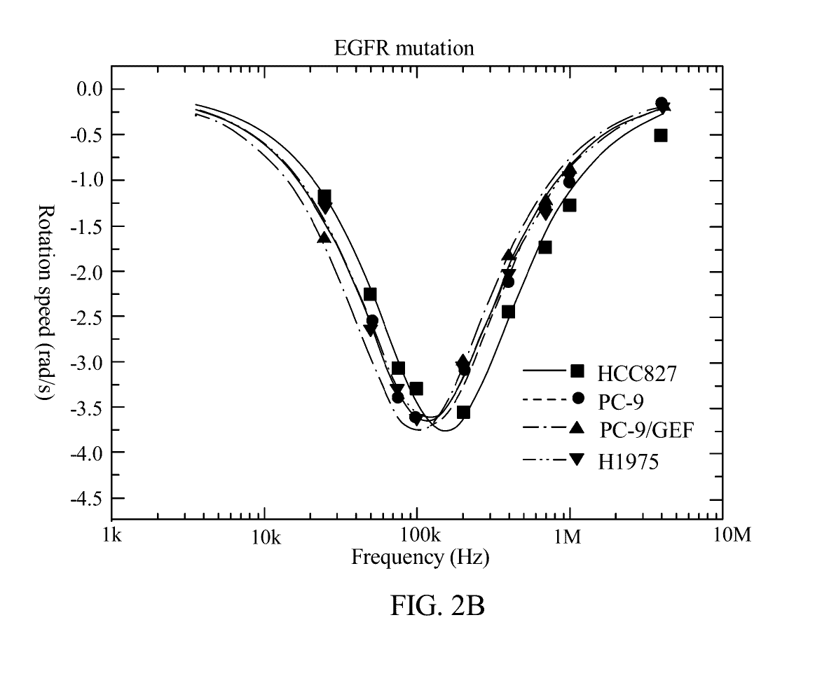

Experiment 1-1: detecting the rotating speeds of the cells to determine the treatment response including messaging inhibition, proliferation inhibition/cells kill caused by the targeted drug EGFR TKI, and using the corresponding biochemical and cell analysis method to confirm the treatment response. In different lung cancer cells, before administrating EGFR TKI, the trend of the electrorotation speeds corresponding to different frequency of the electric signal is analyzed. The results as shown in FIGS. 2A to 2B can be found that the cells without mutation of epithelium growth factor receptor (AS2, A549, H460, and H157) and the cells with mutation of epithelium growth factor receptor (HCC827, PC-9, PC-9/GEF, and H1975) have no significant difference between their rotation speed curves.

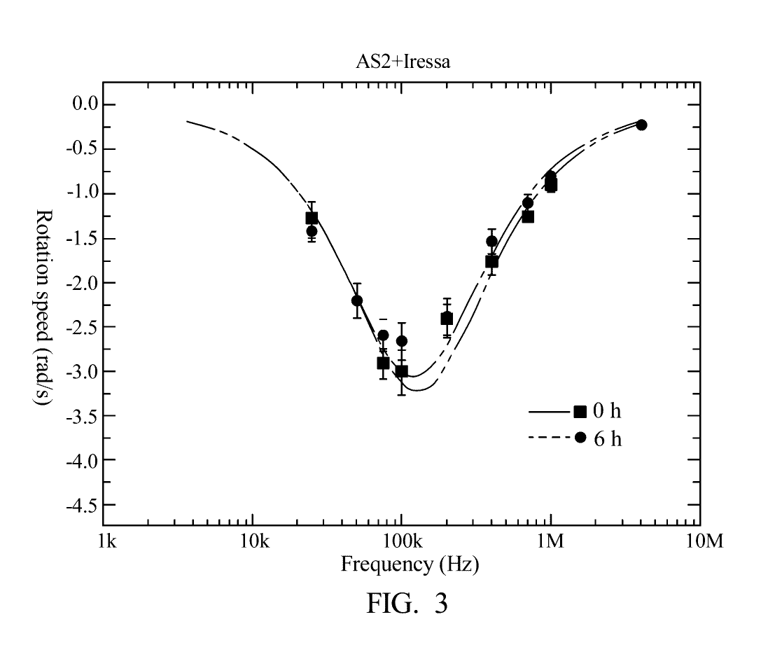

Referring to FIG. 3, it can be observed that the drug resistant cell without mutation of epithelium growth factor receptor (AS2) before (0 hr) and after (6 hrs) treated with EGFR TKI have no significant difference between the rotation speeds.

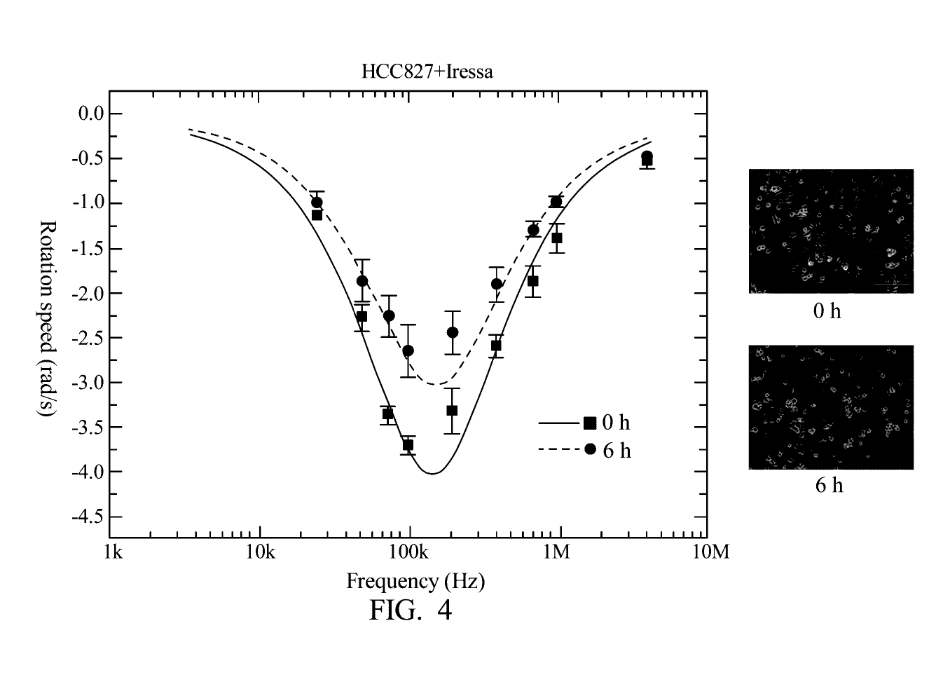

Referring to FIG. 4, it can be observed that the sensitive cell with mutation of epithelium growth factor receptor (HCC827) after treated with EGFR TKI has electrorotation speeds slower than the sensitive cell with mutation of epithelium growth factor receptor before treated with EGFR TKI. However, the sensitive cells do not present significant cell death situation at the time point.

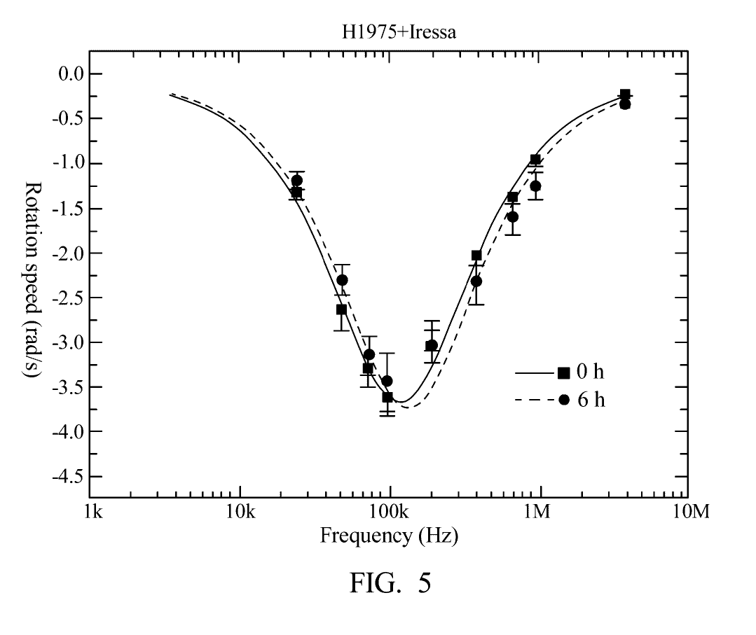

Referring to FIG. 5, it can be observed that the drug resistant cell H1975 (formerly sensitive, but drug resistant after drug therapy for a period) before (0 hr) and after (6 hrs) treated with EGFR TKI have no significant difference between the rotation speeds. According to this result, it can be known that when the rotating speed slows down after EGFR TKI treatment, this cell is responding (sensitive) to the EGFR TKI treatment. When the rotating speed are identical before and after the EGFR TKI treatment, if the cell has never been treated with EGFR TKI, the cell is non-responding to the EGFR TKI treatment (primary drug resistance); if the cell has ever been treated with EGFR TKI, the cell is also nonresponding to the EGFR TKI treatment (acquired drug resistance during treatment).

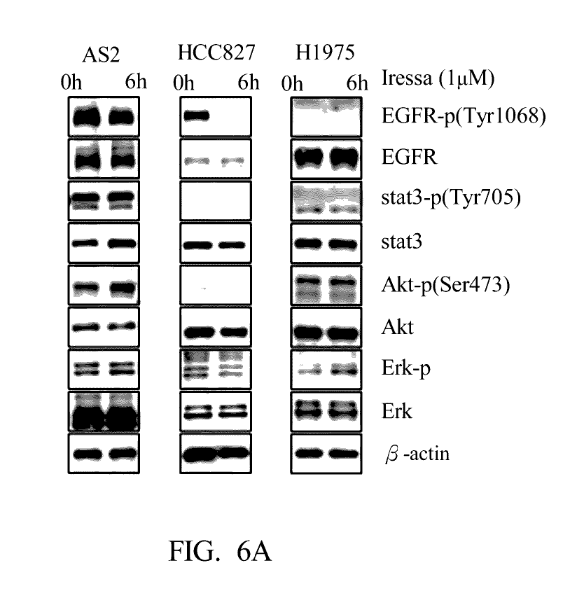

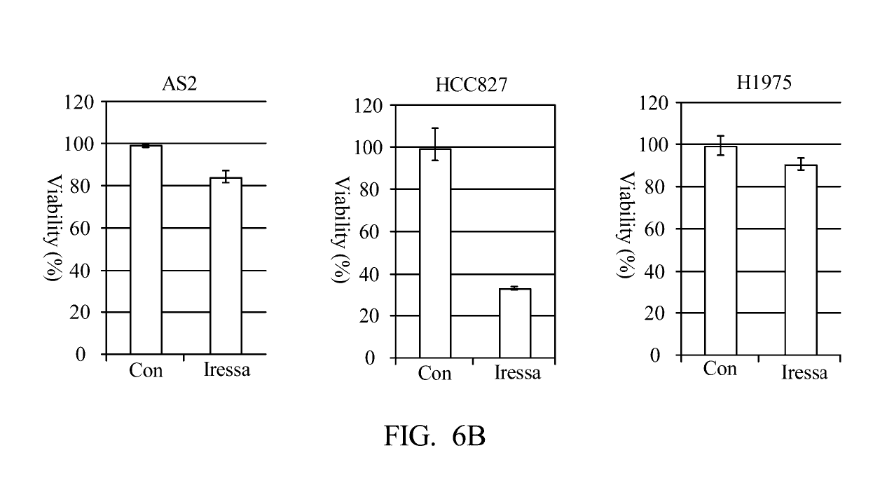

Referring to FIGS. 6A to 6B, from the results of the corresponding biochemical analysis (Western blot) and cell analysis (MTT test) which require more amount of sample cells, the cell message inhibition and proliferation inhibition/cells kill of the drug-resistant cell AS2 are non-obvious; the corresponding biochemical analysis and cell analysis of the sensitive cell HCC827 indicate that the cell message inhibition and proliferation inhibition/cells kill are obvious; the corresponding biochemical analysis and cell analysis of the drug-resistant cell H1975 indicate that the cell message inhibition and proliferation inhibition/cells kill are non-obvious. Comparing the above results with the results of electrorotation, it can be found that they can be connected. The drug-resistant cells AS2 analyzed by electrorotation have no difference between the rotating speed curves of the cells before and after the treatment method, and the cell message inhibition and proliferation inhibition/cells kill are non-obvious; the sensitive cells HCC827 analyzed by electrorotation have significant difference between the rotating speed curves of the cells before and after the treatment method, and the cell message inhibition and proliferation inhibition/cells kill are obvious; the drug-resistant cells H1975 analyzed by electrorotation have no difference between the rotating speed curves of the cells before and after the treatment method, and the cell message inhibition and proliferation inhibition/cells kill are non-obvious. It can be known from this result that the changes of the electrorotation speeds can be used for estimating the treatment response of the EGFR TKI, especially in the lung cancer cells, the treatment response includes cell message inhibition and proliferation inhibition/cells kill which are the important indexes to determine whether the treatment is effective. Therefore, the conclusion of the treatment response of cells to the treatment method can be obtained fast by using electrorotation, and the treatment effect of the clinical treatment can be estimated with high reliability, so that the analysis period can be substantially shorten (6 hrs v.s.72 hrs). In addition to distinguish the sensitive patient suitable for EGFR TKI from the primary drug resistant patient unsuitable for EGFR TKI before the first EGFR TKI treatment, the method can be applied to the sensitive patient to monitor the acquired drug-resistance of EGFR TKI after the EGFR TKI treatment, thereby assisting to find the acquired drug resistance early and adjust to the appropriate treatment (such as second generation, third generation EGFR TKI) to obtain better disease control.

Experiment 1-2: detecting the variation of the electrorotation speed to determine the tumor inhibition caused from the radiation therapy. Different doses of radiation or a placebo treatment (0 Gy, all steps are the same with the experiment cases, for example, the cells are removed from the incubator to the radiation device, and then placed on the radiation device for a period, but the radiation is not applied thereto) are administrated to PC-9 lung cancer cells, and then the electrorotation and the corresponding cell analysis (cell culture formation) are performed to detect the rotating speeds of the cells and the tumor inhibition of the cells caused by the radiation.

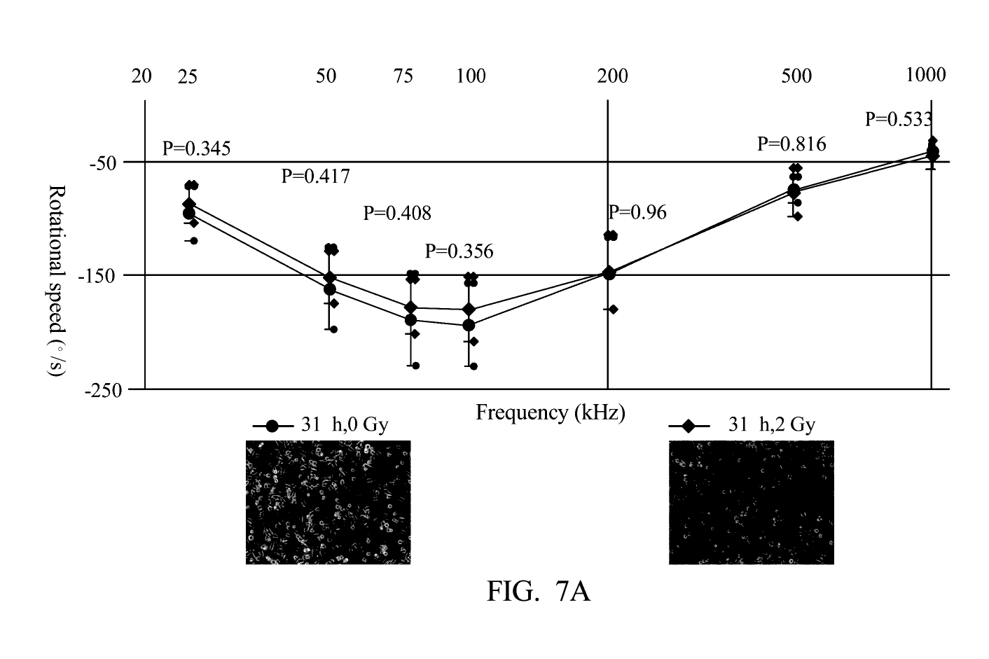

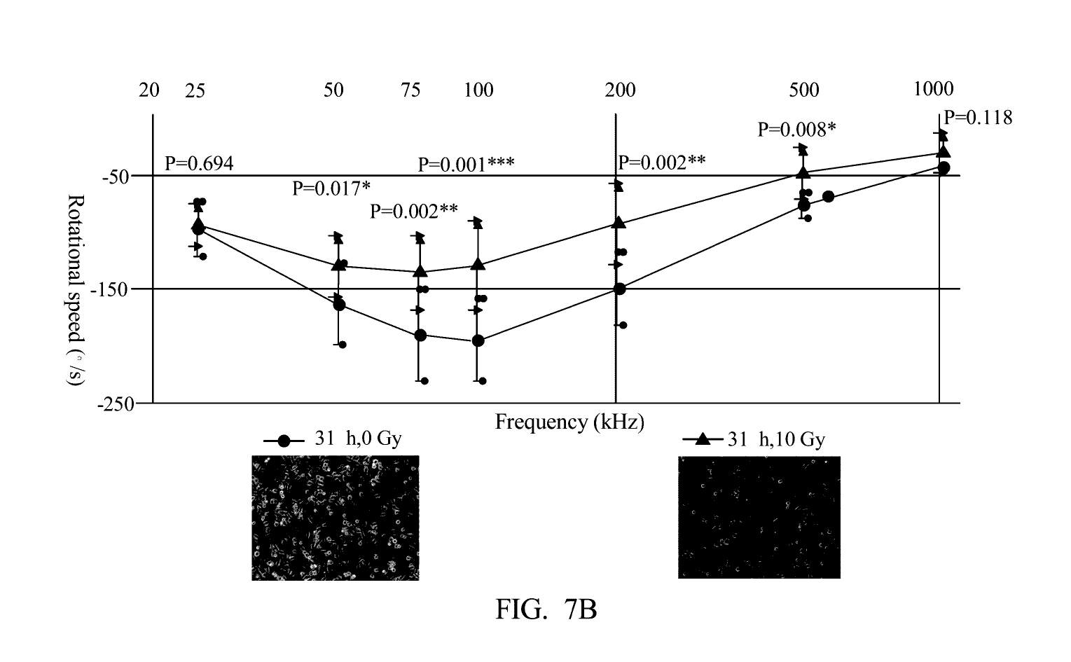

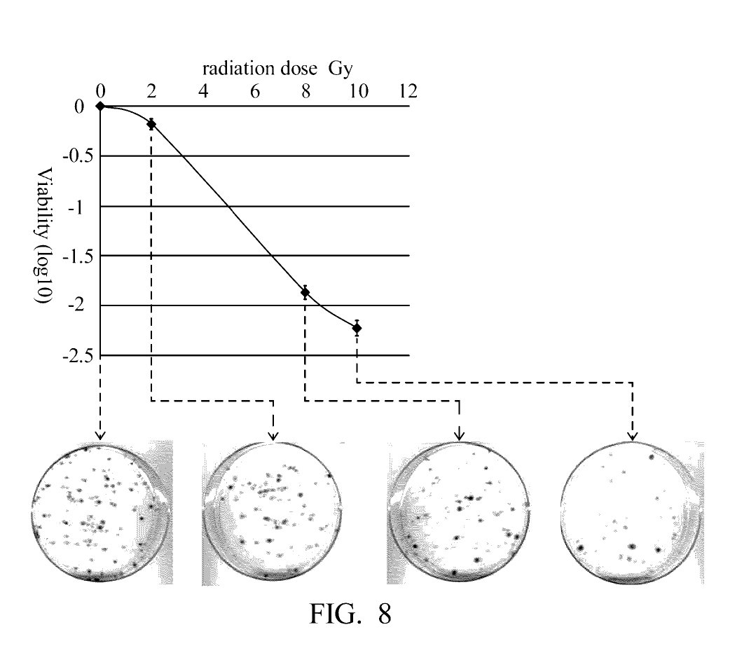

Referring to FIGS. 7A and 7B, compared with the cells of placebo treatment (0 Gy), the cells in lower dose (2 Gy) of radiation has no significant change in the electrorotation behavior (FIG. 7A); the cells in higher dose (10 Gy) of radiation has obvious change in the electrorotation speeds (FIG. 7B), which is meaningful for statistics. Before electrorotation (31 hours after placebo treatment or radiation therapy) the cells do not show obvious cells death. As shown in FIG. 8, in a cell culture formation (Colony Formation Assay) ananlysis, 200 cells are added into each cell plate for the placebo treatment (0 Gy) and the low dose radiation (2 Gy); and 10000 cells are added into each cell plate for the high dose of radiation (8 Gy and 10 Gy). The cell culture formation analysis is performed 2 weeks later. The low dose radiation does not inhibit the tumor development, but the high dose radiation obviously inhibits the tumor cells. From this result, it can be known that the difference between the electrorotation speed curves of the cells treated before and after the radiation therapy can be used for representing the treatment response of the radiation therapy, and the treatment response is the tumor inhibition, which is an important indicator for determining whether the clinical treatment is effective. Therefore, the conclusion of the treatment response of cells to the treatment method can be obtained fast by using electrorotation, and the treatment effect of the clinical treatment can be estimated with high reliability, so that the analysis period indeed can be substantially shorten (31 hrs v.s. 2 weeks).

### Experiment 2: Traveling-Wave Dielectrophoresis

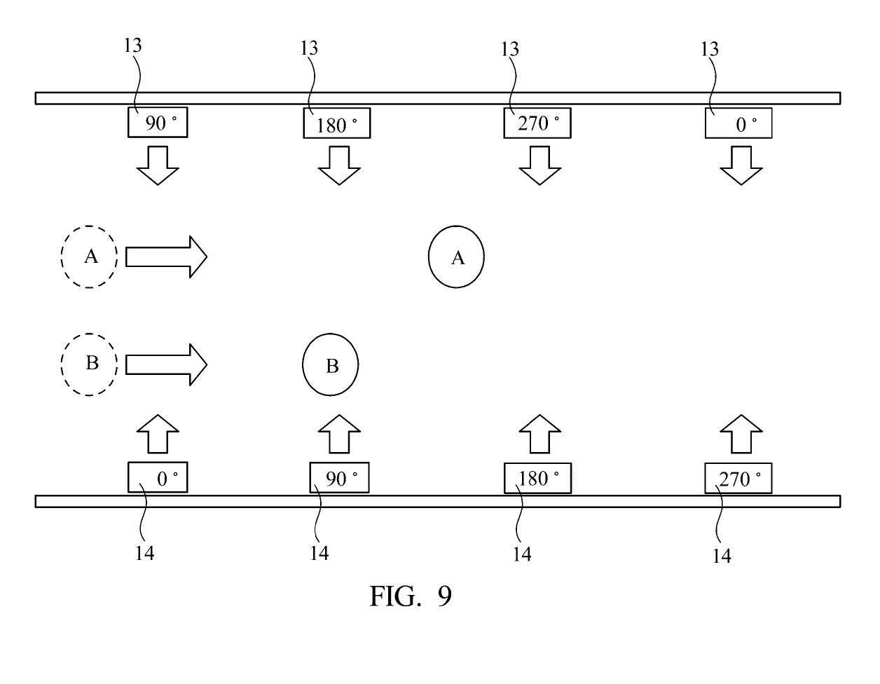

As shown in FIG. 9, a method by using traveling-wave dielectrophoresis (Traveling-wave DEP) device can detect with a single channel or multi-channel (more than 2 channels) planar or 3D biochip. The principle of the traveling-wave dielectrophoresis is similar with the electrorotation. The test cells can be pushed away by the electrodes when applying a negative electrophoresis force (nDEP) through two set of parallel electrode 13 and 14, so that the influence on the moving condition resulting from the friction between the test cells and chip surface can be reduced. The two set of parallel electrode 13 and 14 individually include several electrodes having a width ranged from 0.1 to 1000 microns, preferably 0.5 to 100 microns, for example 1 micron, 20 microns, 40 microns, 50 microns, or 60 microns; the width of the intervals ranged from 0.1 to 1000 microns, preferably 0.5 to 100 microns, for example 1 micron, 20 microns, 40 microns, 50 microns, or 60 microns. Moreover, in this uneven electric field, the electric signal has a periodic variation in value and direction (such as a sine wave), for example, 360/N of sine wave signal are subsequently applied to the parallel electrodes, wherein N is preferably equal to 4, so that the sine wave of the electrodes have intervals of 90 degrees from each other, but N is not limited thereto. The wave signal of each electrode continuously changes the phase thereof by time to provide the source of the moving force for traveling-wave electrophoresis. The frequency of the wave signal is 000.1 KHz to 10 MHz, preferably 10 KHz to 1 MHz, for example 75 KHz, 100 KHz, 150 KHz, 200 KHz, 500 KHz, or 800 KHz, but it is not limited thereto; the voltage is 0.01 V to 100 V, preferably 0.1 V to 10 V, but it is not limited thereto. The cell A and the cell B are influenced by the electric field to generate induced charges which form an induced dipole moment in each of the cells, wherein the direction of the induced dipole moment is opposite to the direction of the electric field applied thereto. In the instant next to the electric field applied, the cells need time to generate the induced dipole moment and then align to the direction of the electric field, and thus generate a force for moving the cells along the parallel electrodes, that is called traveling effect. A 3D biochip is preferable because the traveling force can be provided on and under the 3D biochip.

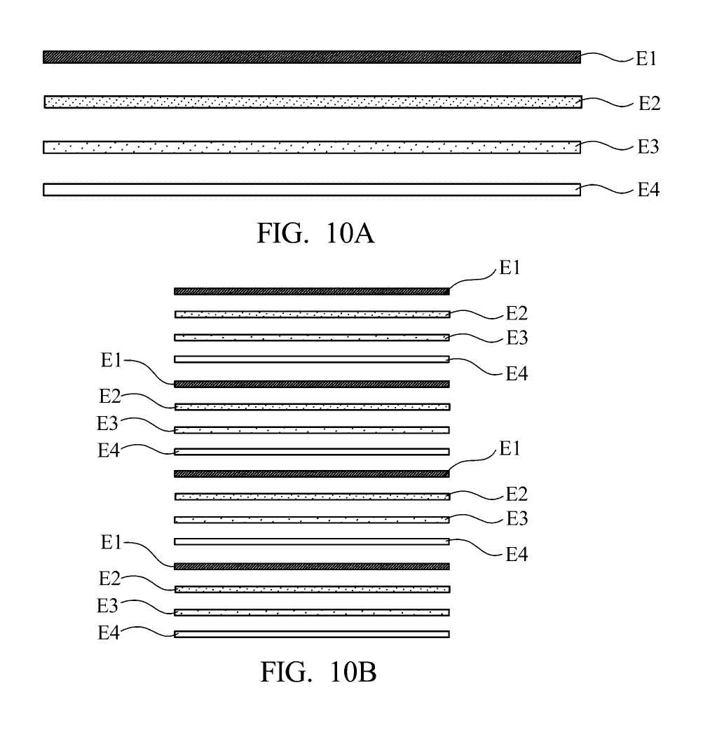

As shown in FIG. 10A, the electrodes for the traveling-wave dielectrophoresis are arranged as a set of electrode including four electrodes E1, E2, E3, and E4 parallel to each other, or several sets of parallel electrode as shown in FIG. 10B, but it is not limited thereto. Furthermore, the electrodes having other shapes can also be used, as long as they are parallel to each other, for example, the enclosed or semi-enclosed multilateral electrodes (e.g. enclosed triangular electrode, semi-enclosed triangular electrode, enclosed rectangular electrode, semi-enclosed rectangular electrode); circular (concentric circle) or oval electrode (enclosed circular electrode, semi-enclosed circular electrode); enclosed irregular pattern electrode, semi-enclosed irregular pattern electrode, sawtooth shaped electrode, combined configuration electrode, or the combination thereof, but they are not limited thereto.

### Experiment Process

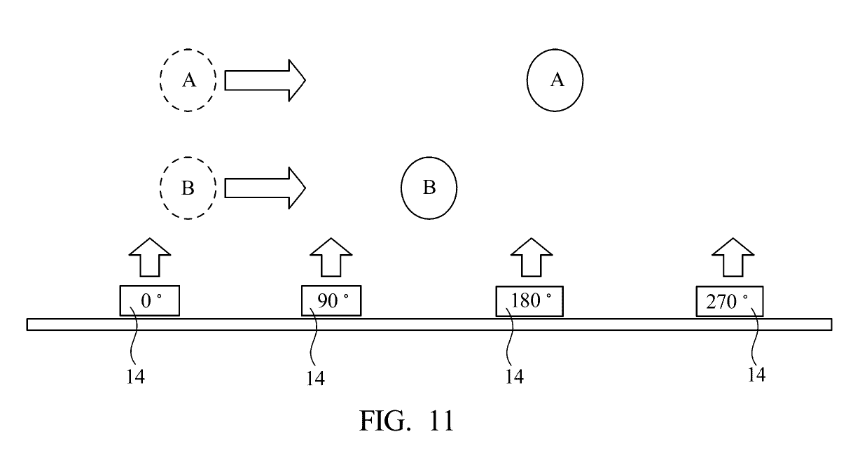

Step. 1: As shown in FIG. 11, the test cells A and B are placed into an electrolyte liquid with an appropriate conductivity, pH value, and osmolarity, and then disposed on a carrier (not shown). The carrier is for example a biochip. The conductivity is ranged from 0.01 to 100 mS/cm, preferably 0.1 to 10 mS/cm, for example 0.1, 1, or 10 mS/cm, but it is not limited thereto; the pH value is ranged from 5.5 to 8.5, for example 7.0, 7.2, or 7.4, but it is not limited thereto; the osmolality is ranged from 50 to 2000 mOsm/kg, for example 270, 300, or 330 mOsm/kg, but it is not limited thereto. The cells can locate at the same space with the electrodes, or preferably, be spaced (contactless) by other device for reducing the damage caused by the electrodes on the cells and the consumption of the electrodes. The electrolyte liquid containing the cell a and the cell B is placed into a containing space on the carrier, and the carrier is disposed on the set of parallel electrode 14.

Step 2: A negative electrophoresis force is applied through the set of parallel electrode 14, and the cell A and the cell B can be pushed to start moving.

Step 3: 360/N of sine wave signal are subsequently applied to the set of parallel electrode 14, wherein N is preferably equal to 4, so that the sine wave of the electrodes have intervals of 90 degrees from each other, but N is not limited thereto. The wave signal of each electrode continuously changes the phase thereof by time to provide the source of the moving force for traveling-wave electrophoresis, thereby generating a dipole moment effect (e.g. movement) to the cell A and the cell B.

Step 4: Observing or recording the movement condition of the cell A and the cell B. An image device such as charge-coupled device (CCD), complementary metal-oxide-semiconductor (CMOS), and other appropriate observation device can be used together with microscopes, but they are not limited thereto.

Step 5: Calculating moving speeds of the cells by using image analysis software (e.g. Image J) or manual analysis, but it is not limited thereto.

Step 6: Analyzing the cell treated by a treatment method (e.g. targeted therapy, radiation therapy, or chemotherapy) to obtain relation and the relative degree between the variation of the electrodynamic effect and the treatment response, and further estimate the treatment effect of the cell treated by the treatment method. The treatment response comprises, but not limited to, messaging inhibition, cell culture formation, or proliferation inhibition/cells kill.

Treatment Method: Chemotherapy with Taxol.

Experiment 1: detecting the variation of the moving speeds of the cells to determine the proliferation inhibition/cells kill caused by Taxol for chemotherapy.

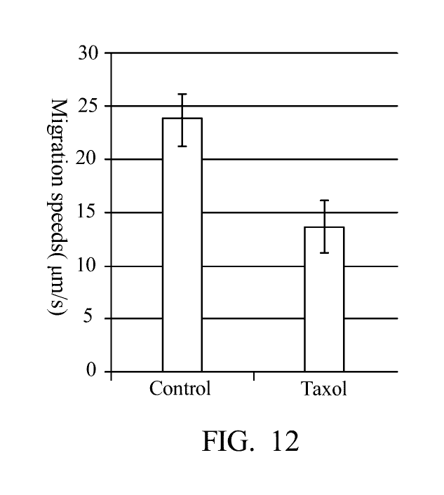

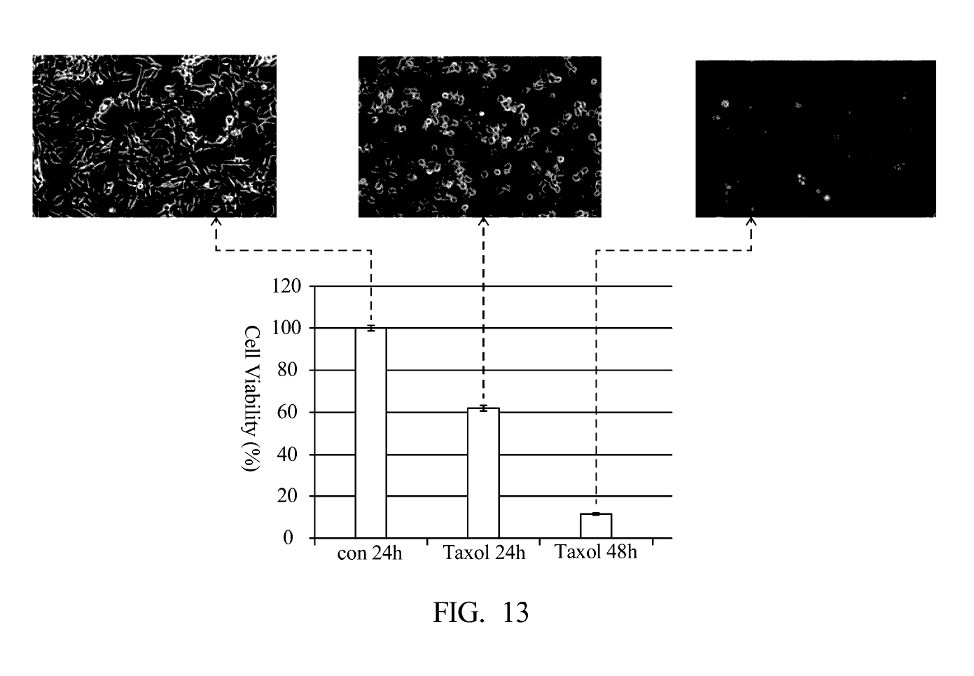

The moving speed of the cell can be obtained by analyzing the moving distance perpendicular to the electrode at different time points. The result is shown in FIG. 12. It can be found that the EGFR TKI drug resistant lung cancer cells without mutation of EGFR AS2 24 hours after Taxol treatment has moving speed much slower than the cells 24 hours after treated by the placebo (only DMSO). As shown in FIG. 13, the corresponding cell analysis also indicates that the Taxol treatment cause obvious cell death (48 hours) and proliferation inhibition/cells kill (24 hours and 48 hours). From these results, it can be understood that, after chemotherapy, the difference between the moving speeds obtained from the traveling-wave dielectrophoresis can indicate the treatment response of the chemotherapy. The treatment response includes proliferation inhibition/cells kill which are the important indicators for determining whether the chemotherapy is effective on clinical. Therefore, the conclusion of the treatment response of cells to the treatment method can be obtained fast by using electrorotation, and the treatment effect of the clinical treatment can be estimated with high reliability, so that the analysis period indeed can be substantially shorten (24 hrs v.s. 48 hrs).

### Experiment 2: Traveling-Wave Dielectrophoresis Applied to Different Specimens

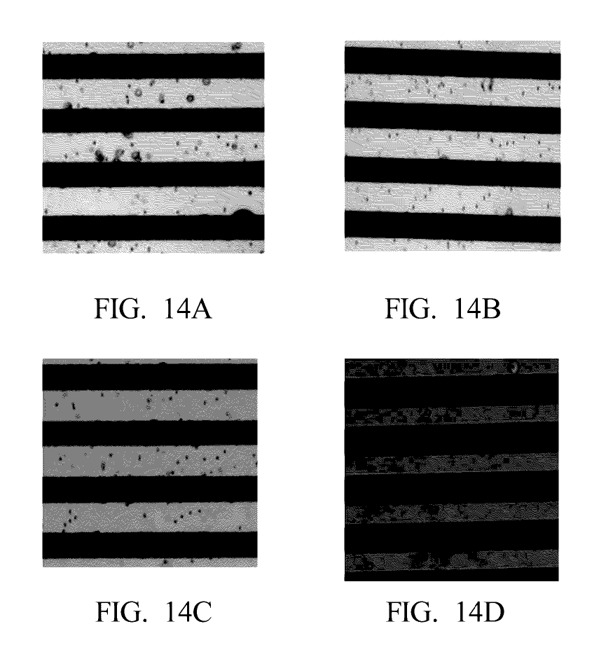

Referring to FIGS. 14A to 14D, it can be found that the different sources of the cells do not influence on the method for determining the treatment response of the cells. The traveling-wave dielectrophoresis is still available to observe the motion behavior. Therefore, the test cells having low purity do not need to purify or recovery through complicated process, and can be used to obtain the results with high reliability. Preferably, the purity of the test cells can be ranged from 0.01 to 100%, for example 0.1%, 1%, or 10%, but it is not limited thereto; the number of the test cells can be ranged from 1 to 100000, for example 1, 3, 10, or 100, but it is not limited thereto. In addition, the biochip separation and the traveling-wave dielectrophoresis can be combined, or the density gradient separation and the traveling-wave dielectrophoresis can be performed at the same time. Furthermore, the different electric parameters (frequency, voltage) or different traveling-wave dielectrophoresis chips (with different width, intervals) can be subsequently utilized to analyze different type of cells in the same sample according to the property of the cells to simplify the analysis process and increase convenience.

Compared to the conventional technology, the method for determining a treatment response of cells of the present invention utilize an electrodynamic method to detect the specimen having low purity of the cells effectively, and obtain the variation of the dipole moment effect of the treated cells during a shorter period. In addition, the motion parameters corresponding to the dipole moment effect is used for establishing the relationship between the treatment method and the treatment response which is especially measured from the cell and biochemical analysis, such as the messaging inhibition, and proliferation inhibition/cells kill of the cancer cells caused by targeted drug which inhibits EGFR, the tumor inhibition of the cancer cells caused by the radiation therapy, and the proliferation inhibition/cells kill of the cancer cells caused by the chemotherapy drugs, which are highly associated with the therapeutic effect on the clinical treatment. Therefore, it is possible to estimate the treatment response of a specific cell before the cell is treated by a specific treatment method, or, it can be served as a fast screen method, or used for comparing the effects of different agents (it is very advantageous because only a small amount of cells are required in this analysis), and the method is of great worth in the case of a limited time.

In addition, comparing to the electrorotation, the traveling-wave DEP has high throughput for determining the treatment response of the cells, and the data analysis of the traveling-wave DEP is easier than that of the electrorotation. Thus, the traveling-wave DEP is a more preferable than the electrorotation according to the present invention.

The present invention has been described with preferred embodiments thereof and it is understood that many changes and modifications to the described embodiments can be carried out without departing from the scope and the spirit of the invention that is intended to be limited only by the appended claims.

What is claimed is:

1. A method for determining a treatment response of cells, comprising steps of:
(1) providing a first sample containing a first cell and an electrolyte liquid, and a second sample containing a second cell and the electrolyte liquid, wherein the first cell and the second cell are the same type of cells obtained from a specimen, the second cell is treated by a treatment method, and the first cell is not treated by the treatment method or treated by a comparative treatment method;
(2) applying an electric signal to the first sample and the second sample so as to generate a dipole moment effect on the first cell and a dipole moment effect on the second cell, respectively;
(3) obtaining at least one first motion parameter from the first cell corresponding to the electric signal, and at least one second motion parameter from the second cell corresponding to the electric signal; and
(4) comparing the first motion parameter and the second motion parameter to determine a treatment response of the second cell to the treatment method;
wherein a difference between the first motion parameter and the second motion parameter represents that the treatment response exists; or no difference between the second motion parameter and the first motion parameter represents that the treatment response does not exist.

2. The method according to claim 1, wherein in the step (2), the dipole moment effect of the first cell and the dipole moment of the second cell are generated by an electrodynamic method so that the first cell is allowed to move, change a moving direction, accelerate, slow down, rotate, change a rotating direction, increase a rotating speed, decrease a rotating speed, or be motionless; and the second cell is allowed to move, change a moving direction, accelerate, slow down, rotate, change a rotating direction, increase a rotating speed, decrease a rotating speed, or be motionless.

3. The method according to claim 2, wherein the electrodynamic method is dielectrophoresis, traveling-wave dielectrophoresis, or electrorotation.

4. The method according to claim 1, wherein the first motion parameter and the second motion parameter are rotating directions, rotating speeds, rotating angles, rotating angular accelerations, moving directions, moving speeds, moving distances, or accelerations.

5. The method according to claim 1, wherein the treatment method is selected from a group consisting of targeted therapy, radiation therapy, chemotherapy, cell death inhibiting therapy, proliferation accelerating therapy, proliferation inhibiting therapy, angiogenesis accelerating therapy, angiogenesis inhibiting therapy, immune activation therapy, immunosuppressive therapy, thermal therapy, photodynamic therapy, differentiation accelerating therapy, differentiation inhibiting therapy, and the combination thereof.

6. The method according to claim 1, wherein the comparative treatment method is a placebo treatment method, or an invalid treatment method.

7. The method according to claim 1, wherein the treatment response is activation, deactivation, cell death acceleration, cell death inhibition, proliferation acceleration, proliferation inhibition, angiogenesis acceleration, angiogenesis inhibition, immunity activation, immunity suppression, injury, differentiation acceleration, differentiation inhibition, or the combination thereof.

8. The method according to claim 1, wherein the first cell and the second cell are blood cells, mesenchymal stem cells, circulating tumor cells, tumor cells, non-tumor cells, malignant cells, non-malignant cells, gene recombinant cells, non-gene recombinant cells, stem cells, non-stem cells, cancer stem cells, artificial differentiated cells, in vitro cultured cells, xenograft cells, or the combination thereof.

9. The method according to claim 1, wherein the specimen is treated by a pre-treatment, or not treated by a pre-treatment, or the combination thereof.

10. The method according to claim 9, wherein the pre-treatment is a physical treatment, a chemical treatment, a biological treatment, or the combination thereof.

11. The method according to claim 9, wherein the pre-treatment comprises at least one method selected from a group consisting of biochip method, density gradient method, magnetic bead method, flow cytometry method, optical driving method, selective osmotic cell lysis method, particle size selective screening method, enzyme digestion method, in vitro cultivation method, centrifugation method, selective affinity method, and the combination of other physical, chemical, or biological treatment.

12. The method according to claim 1, wherein the specimen comprises body fluids, solid tissues, a non-organized specimen, an in vitro cultivated specimen, an xenograft specimen, or the combination thereof.

13. The method according to claim 1, wherein, when the treatment response exists, the treatment response, according to the degree of the difference, is classified into responding type, intermediate type, and a type requiring other indexes to determine; when the treatment response does not exist, the treatment response is determined as non-responding type.

14. The method according to claim 13, wherein the responding type represents sensitivity to the treatment method; and the nonresponding type represents resistance to the treatment method including de novo resistance and acquired resistance.
